(19) United States
(12) Patent Application Publication
(10) Pub. No.: US 2023/0287802 A1
(43) Pub. Date: Sep. 14, 2023

(54) LEAK DETECTION SYSTEM FOR ANTI-ICE DUCTS

(71) Applicant: ROHR, INC., Chula Vista, CA (US)

(72) Inventors: PHILIP J. BJORNSSON, Chula Vista, CA (US); WILLIAM OEI, San Diego, CA (US)

(73) Assignee: ROHR, INC., Chula Vista, CA (US)

(21) Appl. No.: 17/586,531

(22) Filed: Jan. 27, 2022

(51) Int. Cl. F01D 21/12; F01D 25/02; F01D 25/24

(52) U.S. Cl. CPC F01D 21/12; F01D 25/02; F01D 25/24; F05D 2260/60; F05D 2260/80

(57) ABSTRACT

An inlet cowl may comprise: a forward bulkhead; an aft bulkhead spaced apart axially aft of the forward bulkhead; an annular structure having a radially inner wall spaced apart from a radially outer wall; a fluid conduit extending axially through an aft plenum defined axially between the aft bulkhead and the forward bulkhead, the aft plenum defined radially between the radially inner wall and the radially outer wall; and an over-temperature indication assembly coupled to at least one of the radially outer wall and the aft bulkhead, the over-temperature indication assembly configured to transition from a retracted state to a deployed state in response to a portion of the over-temperature indication assembly exceeding a temperature threshold.

### FIELD

The present disclosure relates to gas turbine engines and, more particularly, to anti-ice systems used in aircraft nacelles that surround gas turbine engines.

### BACKGROUND

During operation of an aircraft, atmospheric conditions may lead to the formation of ice on the surfaces of the aircraft. Ice formation on aircraft surfaces, such as on the inlet of a gas turbine engine nacelle, is undesirable and can lead to potentially compromised flying conditions. For example, the formation and accretion of ice on aircraft surfaces may adversely affect the performance of the aircraft by altering the shape of various aerodynamic surfaces of the aircraft. Further, ice accretion on the nacelle inlet surfaces of a gas turbine engine may detach and be drawn through the engine, resulting in the potential for damage to the engine.

To address the above concerns, aircraft may include anti-icing systems to prevent ice formation and accretion on, or to remove ice from, aircraft surfaces. One method of implementing such anti-icing systems is to direct heated gases from the gas turbine engine (e.g., engine bleed air) to interior or exterior surfaces of the aircraft, thereby increasing the temperature of the targeted surfaces. These anti-icing systems may use a double duct configuration to transmit heated gases from the gas turbine engine to the targeted aircraft surface, thereby minimizing the risk of damage to aircraft components (e.g., the acoustic composite structure defining an inner wall of a nacelle inlet) as a result of a ruptured duct.

Although risk of damage may be minimized, an undetected leak may result in damage if left unaddressed. In this regard, an undetected leak in the anti-icing air duct may result in permanent nacelle component damage, airplane delays, and/or flight cancellations.

### SUMMARY

An inlet cowl is disclosed herein. The inlet cowl may comprise: a forward bulkhead; an aft bulkhead spaced apart axially aft of the forward bulkhead; an annular structure having a radially inner wall spaced apart from a radially outer wall; a fluid conduit extending axially through an aft plenum defined axially between the aft bulkhead and the forward bulkhead, the aft plenum defined radially between the radially inner wall and the radially outer wall; and an over-temperature indication assembly coupled to at least one of the radially outer wall and the aft bulkhead, the over-temperature indication assembly configured to transition from a retracted state to a deployed state in response to a portion of the over-temperature indication assembly exceeding a temperature threshold.

In various embodiments, the inlet cowl further comprises a leading edge spaced apart axially forward of the forward bulkhead and partially defining a forward plenum, the fluid conduit in fluid communication with the forward plenum.

In various embodiments, the over-temperature indication assembly is disposed proximate the fluid conduit.

In various embodiments, the over-temperature indication assembly comprises a housing, a plunger disposed within the housing, a biasing mechanism configured to bias the plunger outward from the housing, and a thermally sensitive valve coupled to the plunger within the housing. The thermally sensitive valve may be configured to melt in response to being exposed to a temperature exceeding the temperature threshold. The biasing mechanism may be a spring. The over-temperature indication assembly may be coupled to the radially outer wall. The housing may comprise a flange, an elongated portion, and a radially inner end, the elongated portion extending from the flange to the radially inner end and defining a recess therein. The thermally sensitive valve may be disposed in the recess proximate the radially inner end.

A nacelle is disclosed herein. The nacelle may comprise: an anti-ice system having a fluid conduit configured to be in fluid communication with a compressor section of a gas turbine engine, the fluid conduit in fluid communication with a forward plenum; an inlet cowl defining the forward plenum and an aft plenum disposed aft of the forward plenum, the fluid conduit extending through the aft plenum and configured to release the fluid in the forward plenum; and an over-temperature indication assembly coupled to the inlet cowl, the over-temperature indication assembly configured to deploy in response to a temperature in the aft plenum exceeding a threshold temperature.

In various embodiments, the over-temperature indication assembly is coupled to a radially outer wall of the inlet cowl.

In various embodiments, the over-temperature indication assembly is coupled to an aft bulkhead of the inlet cowl.

In various embodiments, the over-temperature indication assembly comprises a housing, a plunger at least partially disposed within the housing, a biasing mechanism configured to bias the plunger out of the housing, and a thermally sensitive valve configured to retain the plunger during operation of the gas turbine engine. The biasing mechanism may comprise a spring. The thermally sensitive valve may be disposed proximate the fluid conduit within the aft plenum. The housing may comprise a flange, an elongated portion and a radially inner end, the elongated portion extending radially inward from the flange to the radially inner end. The flange may be coupled to a radially outer wall of the inlet cowl.

A method for installing an over-temperature indication assembly, comprising: forming an aperture through an inlet cowl of a nacelle, the aperture fluidly coupling an external environment to an aft plenum defined axially between an aft bulkhead and a forward bulkhead and radially between a radially inner surface of the inlet cowl and a radially outer surface of the inlet cowl; disposing at least a portion of an over-temperature indication assembly through the aperture; and coupling the over-temperature indication assembly to the inlet cowl, the over-temperature indication assembly configured to transition from a retracted state to a deployed state in response to being exposed to a temperature that exceeds a temperature threshold.

In various embodiments, the aperture is disposed proximate a fluid conduit extending through the aft plenum to a forward plenum defined axially between the forward bulkhead and a leading edge.

In various embodiments, a flange of a housing of the over-temperature indication assembly is coupled to the inlet cowl.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1A is a perspective view of an aircraft having a gas turbine engine, in accordance with various embodiments;

FIG. 1B is a side, cross sectional view of a gas turbine engine, in accordance with various embodiments;

FIG. 1C illustrates a perspective view of a fan cowl having a leak detection system, in accordance with various embodiments;

FIG. 2 illustrates a cross-sectional view of an inlet cowl, in accordance with various embodiments;

FIG. 3A illustrates a leak detection system in a retracted state, in accordance with various embodiments;

FIG. 3B illustrates a leak detection system in a deployed state, in accordance with various embodiments; and

FIG. 4 illustrates a retrofit process, in accordance with various embodiments.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

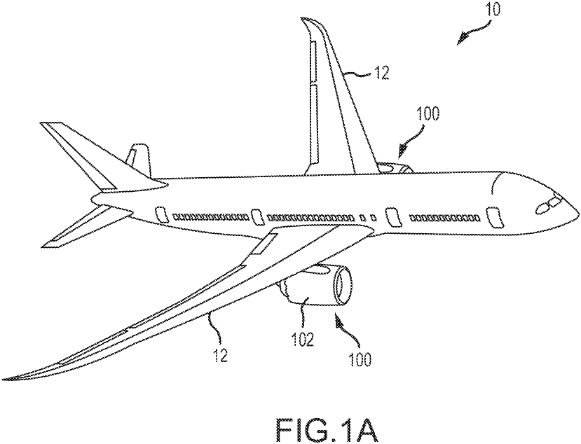

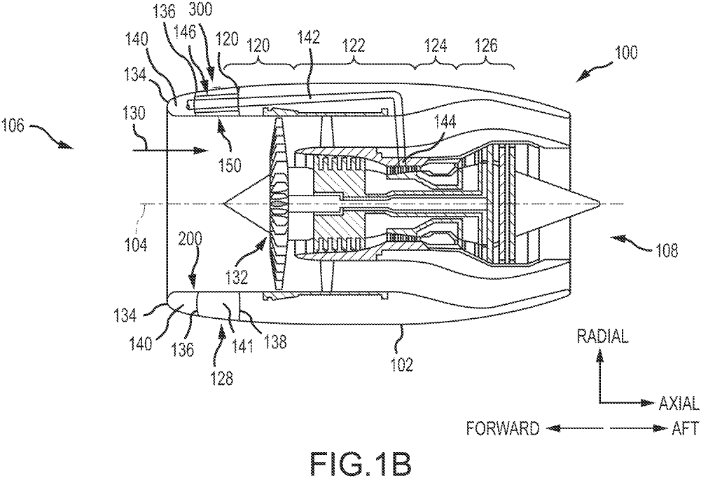

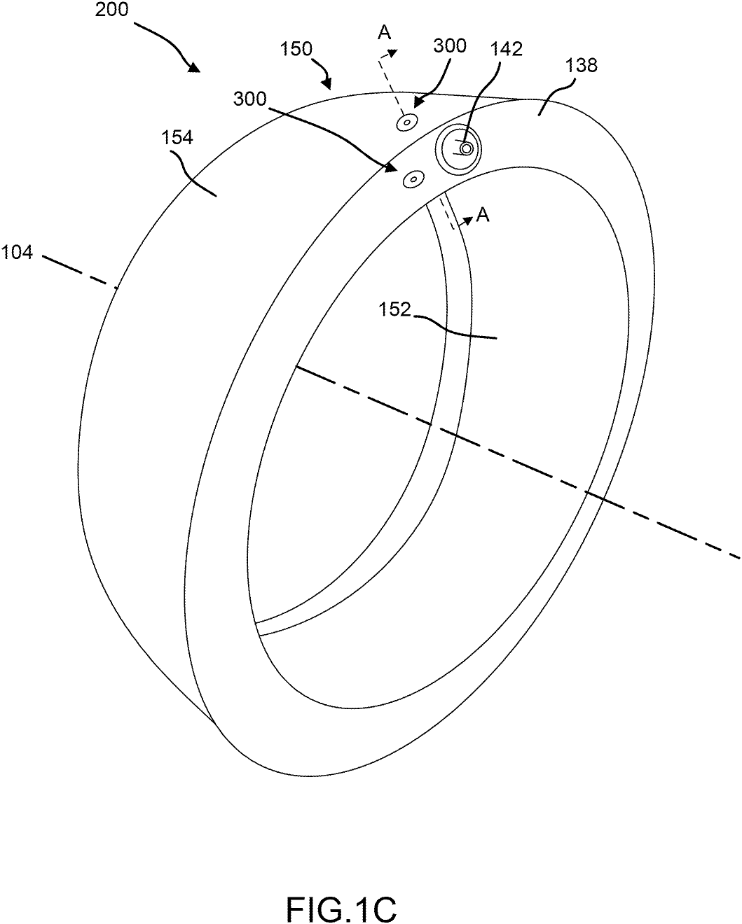

Referring to FIGS. 1A and 1B, an aircraft 10 includes a gas turbine engine 100 mounted to, for example, a wing 12 of the aircraft 10. The gas turbine engine 100 includes a nacelle 102 defining a housing of the gas turbine engine 100 about a longitudinal axis 104. The longitudinal axis 104 extends through the center of the gas turbine engine 100 between a forward end 106 and an aft end 108 of the gas turbine engine 100. The gas turbine engine 100 generally includes a fan section 120, a compressor section 122, a combustor section 124 and a turbine section 126. The nacelle 102 includes an inlet cowl 200. The inlet cowl 200 comprises an inlet surface 128 for directing an air flow 130 toward the fan section 120 and through an inlet section 132. Because the inlet surface 128 is located at the forward end 106, and therefore not heated directly by the gas turbine engine 100, the inlet surface 128 is prone to the accumulation of ice, especially along a forward lip surface 134 (i.e., the leading edge of the nacelle 102).

In various embodiments, the inlet cowl 200 of the nacelle 102 includes a forward bulkhead 136 and an aft bulkhead 138, both of which are annularly arranged about the longitudinal axis 104. The inlet cowl 200 comprises a forward plenum 140 and an aft plenum 141. The forward plenum 140 is defined axially in the inlet cowl 200 between the forward lip surface 134 and the forward bulkhead 136 and radially between a radially inner wall 152 of the inlet cowl 200 and a radially outer wall 154 of the inlet cowl 200. The aft plenum 141 is defined axially in the inlet cowl 200 between the forward bulkhead 136 and the aft bulkhead 138 and radially between the radially inner wall 152 of the inlet cowl 200 and the radially outer wall 154 of the inlet cowl 200. The forward plenum 140 is configured to receive a heated gas that flows through the forward plenum 140 to perform the anti-icing function. In various embodiments, the heated gas is directed to the forward plenum 140 via a fluid conduit 142 configured to bleed the heated gas from the compressor section 122. The fluid conduit 142 extends from a tap 144 at the compressor section 122 and extends to a duct system 146 that extends through the aft plenum 141 from the aft bulkhead 138 to the forward bulkhead 136.

In various embodiments, the duct system 146 may comprise a double-walled duct. In various embodiments, an anti-icing system 150 is configured to deliver the heated gas (e.g., hot air bled from the compressor section 122 of the gas turbine engine 100) to the forward plenum 140 to prevent the formation of ice on the forward lip surface 134.

In various embodiments, the nacelle 102 comprises a detection system 300 coupled to the inlet cowl 200. The detection system 300 is configured to provide a physical indicator in response to a temperature in the aft plenum 141 exceeding a temperature threshold. In this regard, the detection system 300 may be configured to be in a retracted state during normal operation of the gas turbine engine 100 and in a deployed state in response to being activated (i.e., in response to the aft plenum 141 exceeding the temperature threshold). In various embodiments, the detection system 300 may be disposed on the radially outer wall 154 of the inlet cowl 200. However, the present disclosure is not limited in this regard. For example, the detection system 300 may be disposed on the aft bulkhead 138 in a location that would be visible during maintenance. In various embodiments, the detection system 300 is disposed proximal the fluid conduit 142 extending through the aft plenum 141. In various embodiments, a portion of the detection system 300 extends into the aft plenum 141 as described further herein.

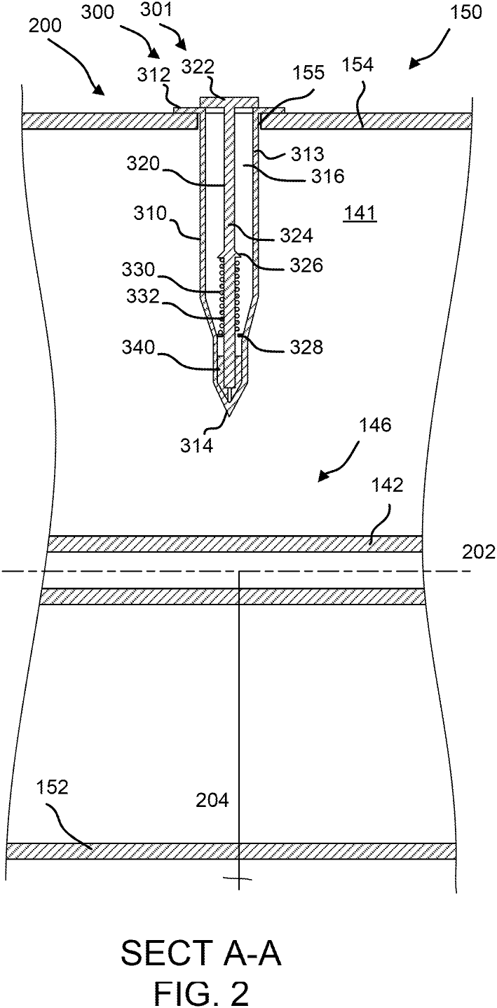

Referring now to FIG. 2, a cross-sectional view of a partition of the anti-icing system 150 along section line A-A from FIG. 1C is illustrated, in accordance with various embodiments. The anti-icing system 150 further comprises the detection system 300. The detection system 300 includes an over-temperature indication assembly 301. The over-temperature indication assembly 301 comprises a housing 310, a plunger 320, a biasing mechanism 330, and a thermally sensitive valve 340.

In various embodiments, the housing 310 is coupled to the radially outer wall 154 of the inlet cowl 200. In various embodiments, the housing 310 is bonded to (e.g., via an adhesive or the like), or mechanically fastened to (e.g., via nut plates, rivets, etc.) the radially outer wall 154. In various embodiments, the housing 310 comprises an elongated portion 313 extending radially inward (i.e., as defined relative to the longitudinal axis 104 from FIGS. 1A-B) from a flange 312 to a radially inner end 314. The elongated portion 313 extends through an aperture 155 in the radially outer wall 154 of the inlet cowl 200. The radially inner end 314 is disposed proximate the fluid conduit 142 disposed in the aft plenum 141. “Proximate”, as referred to herein is within a “zone” in the aft plenum 141. The zone is defined as being between -20 degrees and 20 degrees (i.e., circumferentially) of a line 204 extending in a radial direction from the longitudinal axis 104 from FIGS. 1B-C, through a centerline 202 of the fluid conduit 142 and swept axially along the centerline 202 of the fluid conduit 142. Thus, the radially inner end is disposed as close to the fluid conduit 142, in accordance with various embodiments.

The housing 310 further comprises a blind recess disposed in the flange 312 and extending radially inward to the radially inner end 314 of the housing. In various embodiments, the plunger 320 comprises a plunger head 322 and a rod 324 extending from the plunger head 322 to the thermally sensitive valve 340 disposed adjacent to the radially inner end 314. In various embodiments, the plunger 320 further comprises a flange 326 and a stop 328. The flange 326 may extend radially outward (i.e., radially outward in a radial direction defined from a centerline of the rod 324) from the rod 324. The stop 328 may be spaced apart axially (i.e., axially along an axis defined by the rod 324) from the flange). The biasing mechanism 330 may be disposed axially between the stop 328 and the flange.

In various embodiments, the plunger head 322 and the flange 312 may add minimal, or negligible drag impact to the inlet cowl 200 of the nacelle 102.

In various embodiments, the biasing mechanism 330 may be a spring 332 (e.g., a compression spring, a torsion spring, a tension spring, etc.). Although illustrated in a compression spring configuration, the present disclosure is not limited in this regard. For example, various biasing mechanisms can be envisioned that would bias the plunger 320 in a radially outward (i.e., radially outward from the longitudinal axis 104) direction and be within the scope of this disclosure.

In various embodiments, the thermally sensitive valve 340 is disposed adjacent to the radially inner end 314 of the housing 310. In this regard, the thermally sensitive valve 340 is disposed proximate the fluid conduit 142. In various embodiments, the thermally sensitive valve 340 can be a simple insert configured to be disposed in the cavity 316 of the housing 310. The simple insert may be made of a metal that melts at a desired temperature (e.g., a threshold temperature). The simple insert may be made of eutectic or fusible alloys with low melting points, including alloys of lead, bismuth, and tin, and commonly known by names like Wood’s Metal, Rose Metal, and Lipowitz’s Alloy. Such metals are used in fire sprinkler valves, preventing pressurized water from exiting a pipe until triggered by heat, at which time the alloy softens sufficiently to release the plunger 320.

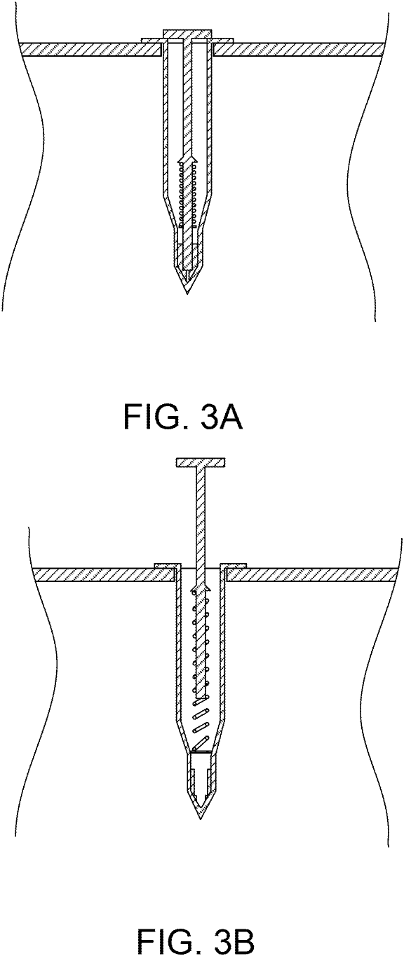

Thus, in response to being exposed to a temperature above a threshold temperature (e.g., during a leakage event of fluid conduit 142), the thermally sensitive valve 340 is configured to melt. In response to the thermally sensitive valve 340 melting, the rod 324 of the plunger 320 may be decoupled from the thermally sensitive valve 340. In this regard, the biasing mechanism 330 is configured to transition the plunger 320 from a retracted state (e.g., FIG. 3A) to a deployed state (e.g., FIG. 3B). In various embodiments, the plunger 320 may be configured in a manner to ensure that the plunger 320 is visible during a crew walkaround or during a scheduled maintenance in accordance with various embodiments. In this regard, the detection system 300 is configured to deploy in response to a hot air duct leak from the fluid conduit 142 in the aft plenum 141 of the inlet cowl 200. In response to deploying, the detection system 300 is configured to provide an indicator (e.g., the deployed plunger as shown in FIG. 3B) for indication during a crew walkaround or a during scheduled maintenance.

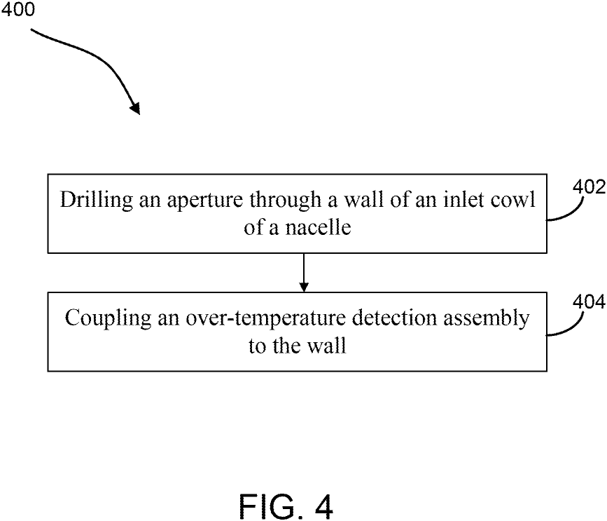

In various embodiments, the design of the detection system 300 from FIG. 2 allows for a retrofitting process on typical inlet cowls. For example, a retrofitting process 400 for retrofitting a detection system 300 onto an inlet cowl 200 from FIG. 2 is illustrated in FIG. 4 in accordance with various embodiments. The retrofitting process 400 comprises drilling an aperture through a wall (e.g., radially outer wall 154 or aft bulkhead 138) of an inlet cowl 200 of a nacelle 102 (step 402). In response to drilling the aperture, an external environment of the inlet cowl 200 may be temporarily fluidly coupled to an aft plenum 141 of the inlet cowl 200.

In various embodiments, the retrofitting process 400 further comprises coupling an over-temperature indication assembly 301 to the wall (e.g., radially outer wall 154 or aft bulkhead 138) (step 404). In various embodiments, coupling the over-temperature indication assembly 301 to the wall may result in a portion of a housing for the over-temperature indication assembly 301 to be disposed proximate a fluid conduit disposed through the aft plenum 141. The fluid conduit may be a component within an anti-icing system 150 as described previously herein.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An inlet cowl, comprising:
a forward bulkhead;
an aft bulkhead spaced apart axially aft of the forward bulkhead;
an annular structure having a radially inner wall spaced apart from a radially outer wall;
a fluid conduit extending axially through an aft plenum defined axially between the aft bulkhead and the forward bulkhead, the aft plenum defined radially between the radially inner wall and the radially outer wall; and
an over-temperature indication assembly coupled to at least one of the radially outer wall and the aft bulkhead, the over-temperature indication assembly configured to transition from a retracted state to a deployed state in response to a portion of the over-temperature indication assembly exceeding a temperature threshold.

2. The inlet cowl of claim 1, further comprising a leading edge spaced apart axially forward of the forward bulkhead and partially defining a forward plenum, the fluid conduit in fluid communication with the forward plenum.

3. The inlet cowl of claim 1, wherein the over-temperature indication assembly is disposed proximate the fluid conduit.

4. The inlet cowl of claim 1, wherein the over-temperature indication assembly comprises a housing, a plunger disposed within the housing, a biasing mechanism configured to bias the plunger outward from the housing, and a thermally sensitive valve coupled to the plunger within the housing.

5. The inlet cowl of claim 4, wherein the thermally sensitive valve is configured to melt in response to being exposed to a temperature exceeding the temperature threshold.

6. The inlet cowl of claim 4, wherein the biasing mechanism is a spring.

7. The inlet cowl of claim 4, wherein the over-temperature indication assembly is coupled to the radially outer wall.

8. The inlet cowl of claim 7, wherein the housing comprises a flange, an elongated portion, and a radially inner end, the elongated portion extending from the flange to the radially inner end and defining a recess therein.

9. The inlet cowl of claim 8, wherein the thermally sensitive valve is disposed in the recess proximate the radially inner end.

10. A nacelle, comprising:
an anti-ice system having a fluid conduit configured to be in fluid communication with a compressor section of a gas turbine engine, the fluid conduit in fluid communication with a forward plenum;
an inlet cowl defining the forward plenum and an aft plenum disposed aft of the forward plenum, the fluid conduit extending through the aft plenum and configured to release the fluid in the forward plenum; and
an over-temperature indication assembly coupled to the inlet cowl, the over-temperature indication assembly configured to deploy in response to a temperature in the aft plenum exceeding a threshold temperature.

11. The nacelle of claim 10, wherein the over-temperature indication assembly is coupled to a radially outer wall of the inlet cowl.

12. The nacelle of claim 10, wherein the over-temperature indication assembly is coupled to an aft bulkhead of the inlet cowl.

13. The nacelle of claim 10, wherein the over-temperature indication assembly comprises a housing, a plunger at least partially disposed within the housing, a biasing mechanism configured to bias the plunger out of the housing, and a thermally sensitive valve configured to retain the plunger during operation of the gas turbine engine.

14. The nacelle of claim 13, wherein the biasing mechanism comprises a spring.

15. The nacelle of claim 14, wherein the thermally sensitive valve is disposed proximate the fluid conduit within the aft plenum.

16. The nacelle of claim 13, wherein the housing comprises a flange, an elongated portion and a radially inner end, the elongated portion extending radially inward from the flange to the radially inner end.

17. The nacelle of claim 16, wherein the flange is coupled to a radially outer wall of the inlet cowl.

18. A method for installing an over-temperature indication assembly, comprising:
forming an aperture through an inlet cowl of a nacelle, the aperture fluidly coupling an external environment to an aft plenum defined axially between an aft bulkhead and a forward bulkhead and radially between a radially inner surface of the inlet cowl and a radially outer surface of the inlet cowl;
disposing at least a portion of the over-temperature indication assembly through the aperture; and
coupling the over-temperature indication assembly to the inlet cowl, the over-temperature indication assembly configured to transition from a retracted state to a deployed state in response to being exposed to a temperature that exceeds a temperature threshold.

19. The method of claim 18, wherein the aperture is disposed proximate a fluid conduit extending through the aft plenum to a forward plenum defined axially between the forward bulkhead and a leading edge.

20. The method of claim 18, wherein a flange of a housing of the over-temperature indication assembly is coupled to the inlet cowl.
